(19) United States
(12) Patent Application Publication
(10) Pub. No.: US 2026/0078804 A1
(43) Pub. Date: Mar. 19, 2026

(54) BEARING DEVICE WITH ELECTRICAL INSULATION INCORPORATED, IN PARTICULAR FOR AN ELECTRIC MOTOR OR ELECTRICAL MACHINE

(71) Applicant: AKTIEBOLAGET SKF, GOTEBORG (SE)

(72) Inventor: Benoit ARNAULT, Saint-Cyr-sur-Loire (FR)

(21) Appl. No.: 19/323,018

(22) Filed: Sep. 9, 2025

(30) Foreign Application Priority Data
Sep. 16, 2024 (FR) 2409812

(51) Int. Cl. F16C 41/00; F16C 19/06

(52) U.S. Cl. CPC F16C 41/002; F16C 19/06; F16C 2380/26

(57) ABSTRACT

A bearing device includes a bearing having first and second rings, a bushing, and an electrically insulating insert overmolded between and connecting the bushing and the second ring. The electrically insulating insert has a first axial end and a second axial end axially spaced from the first axial end, and a first sealing device is secured in a first annular fitting groove of the electrically insulating insert so that it forms a first dynamic annular seal with the first ring.

### CROSS-REFERENCE

This application claims priority to French patent application no. 2409813 filed on September 16, 2024, the contents of which are fully incorporated herein by reference.

### TECHNOLOGICAL FIELD

The present disclosure concerns the field of electrically insulated bearings used in particular in electric motors, electrical machines and associated equipment.

### BACKGROUND

In an electric motor or electrical machine, at least one roller bearing is fitted between the housing of the electric motor or the electrical machine and the rotary shaft in order to support this shaft. In operation, when the shaft is rotating, a difference of electrical potential can appear between the shaft and the housing of the electric motor or of the electrical machine. This can produce an electrical current between the first ring of the roller bearing, which is integral with the shaft, and the second ring, which is integral with the housing. The electrical current which passes through the components of the roller bearing can damage these components, in particular the rolling elements and the races provided on the inner and second rings. The electrical discharges can also generate vibrations.

In order to eliminate these disadvantages, it is known to replace the rolling elements of the bearing which are made of the same steel as that of the inner and second rings, by rolling elements made of ceramic. Reference is then generally made to a hybrid roller bearing. However, a hybrid roller bearing of this type is relatively costly.

In order to eliminate the aforementioned disadvantages, it is also known to equip the second ring of the roller bearing with an insulation sleeve provided with a bushing and an insulating insert made of an electrically insulating material interposed radially between the second ring and the bushing.

In certain applications, environmental pollution can reduce the service life of the bearing.

### SUMMARY

The disclosure concerns a bearing device comprising a bearing having a first ring and a second ring that are configured to rotate relative to one another.

The device also comprises at least one insulation sleeve which is fitted on the second ring of the bearing. The insulation sleeve includes a bushing and an insulating insert interposed radially between the second ring of the bearing and the bushing. The insulating insert is made of electrically insulating material. The bushing has a first cylindrical surface and a second cylindrical surface radially spaced from the first cylindrical surface which together delimit the radial thickness of the bushing.

The insulating insert is overmolded to the second ring of the bearing and to the first cylindrical surface of the bushing, which, in the embodiment disclosed below it the radially inner surface of the bushing.

According to a general characteristic, the device also comprises at least one first sealing device which is secured in a first annular fitting groove of the insulating insert and forms a first dynamic annular seal together with the first ring.

“Dynamic sealing” means sealing between two parts which can have relative movement. In opposition to dynamic sealing, “static sealing” means the sealing provided between two parts which can not have relative movement.

The first dynamic annular seal formed jointly by the first sealing device and by the first ring can be obtained by a narrow passage/narrow passages and/or by friction.

“Annular groove” means a groove which extends around 360°. The base of the groove can be continuous, or alternatively discontinuous, in the circumferential direction. In this second case, the base of the annular groove is constituted by a plurality of continuous surfaces which are spaced from one another in the circumferential direction.

The first sealing device forms a barrier that stops the pollutant particles which can move towards the inner of the bearing.

Preferably, the first annular groove of the insulating insert is open in the direction of the first ring. Advantageously, the insulating insert is over-molded on the second ring of the bearing and to the first cylindrical surface of the bushing. Alternatively, the insulating insert can be secured by any other appropriate means, for example by adhesion.

In the design wherein the insulating insert is obtained by over-molding, this can comprise at least one first release groove which is offset radially on the side of the bushing in relation to the first fitting groove and is formed on a first front face of the lining, with at least a first heel remaining radially between the first fitting and release grooves. This facilitates the axial release of the first fitting groove during the production of the device.

Preferably, the first heel of the insulating insert is provided with a frustoconical surface extending from the first front face, obliquely in the direction of the second ring, and situated radially on the side of the first fitting. This facilitates the fitting of the first sealing device in the inner of the first annular fitting groove of the insulating insert.

According to a particular design, the first sealing device comprises a securing part which is secured in the first annular fitting groove of the insulating insert and is made of rigid material, with the insulating insert being made of flexible electrically insulating material. The first sealing device can comprise a sealing flange. Alternatively, the first sealing device can comprise a seal.

Advantageously, the device also comprises at least one second sealing device, which is secured in a second annular fitting groove of the insulating insert and forms together with the first ring a second dynamic annular seal, with the first and second sealing devices being positioned axially on opposite sides of the second ring. The second dynamic annular seal which is formed jointly by the second sealing device and by the first ring can be obtained by a narrow passage/narrow passages and/or by friction.

The second ring can comprise a first cylindrical surface and a second cylindrical surface opposite the first cylindrical surface surface, which delimit the radial thickness of the second ring, and first and second axially spaced front faces that delimit the axial length of the second ring, with the insulating insert being secured to the second cylindrical surface of the second ring.

The first ring has first and second axially spaced front faces delimiting the axial length of the second ring. The first front face of the second ring and the first front face of the first ring are situated axially on a first side in relation to a median radial plane of the device. The second front face of the second ring and the second front face of the first ring are situated axially on a second side in relation to the median radial plane.

Advantageously, the first front face of the second ring is offset axially inward in relation to the first front face of the first ring, and the first sealing device is situated axially between the first front faces. Thus, the axial global size of the device is not increased, taking into account the presence of the first sealing device. The global weight of the device is also reduced, taking into account the reduced axial length of the second ring in relation to that of the first ring.

Advantageously, the second front face of the second ring is offset axially inward in relation to the second front face of the first ring. When the device is equipped with a second sealing device, this can advantageously be situated axially between the second front faces.

If the insulating insert is made of synthetic material or of elastomer material, it makes it possible to render the device insensitive to the temperature variations. In a particular embodiment, the bushing is made of metal material. The bushing can thus be easily machined to a predetermined radial tolerance. Advantageously, the bushing is obtained from a metal sheet by cutting, stamping and rolling.

In one embodiment, the insulating insert covers all of the surface of the bushing. In this case, the insulating insert covers entirely the surface of the bushing in the axial direction and in the circumferential direction. According to a first design, the bushing delimits the outer surface of the device. In this case, the second ring is the second ring of the bearing. According to a second alternative design, the bushing delimits the inner surface of the device. In this case, the second ring is the first ring of the bearing.

In a particular embodiment, the bearing comprises at least one row of rolling elements positioned between races of the first and second rings. The rolling elements can be made of metal material. The disclosure also concerns an electric motor comprising a housing, a shaft, and at least one bearing device as previously defined, fitted radially between the housing and the shaft.

### BRIEF DESCRIPTION OF THE DRAWINGS

The present disclosure will be better understood by studying the detailed description of embodiments, taken by way of examples which are in no way limiting, and are illustrated by the appended drawings in which:

FIG. 1 is a perspective view of a bearing device according to a first exemplary embodiment of the present disclosure which includes two sealing flanges.

FIG. 2 is a perspective view of the bearing device of FIG. 1 in which one of the sealing flanges has been removed for illustration purposes.

FIG. 3 is a perspective view of one of the sealing flanges of the bearing device of FIG. 1.

FIG. 4 is an axial sectional view of a portion of the bearing device of FIG. 1.

FIG. 5 is an axial sectional view of a portion of the bearing device of FIG. 1 in which the sealing flanges are not shown.

FIG. 6 is an axial section of a portion of a bearing device according to a second exemplary embodiment of the disclosure.

FIG. 7 is an axial sectional view of a portion of a bearing device according to a third exemplary embodiment of the disclosure.

FIG. 8 is an axial sectional view of a portion of a bearing device according to a fourth exemplary embodiment of the disclosure.

### DETAILED DESCRIPTION

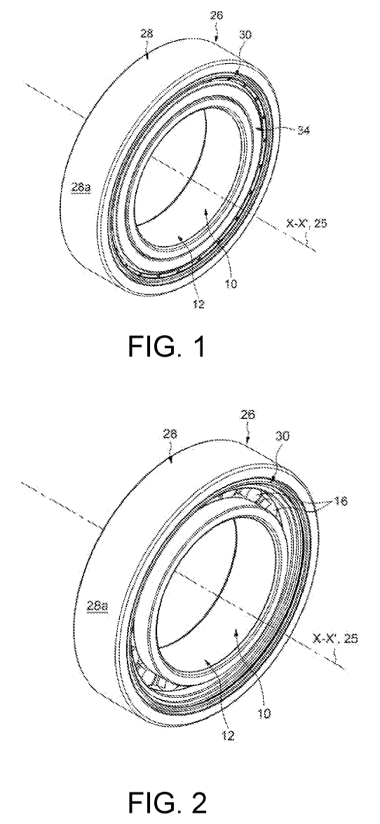

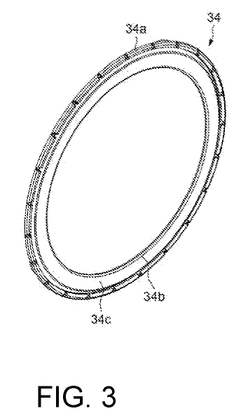

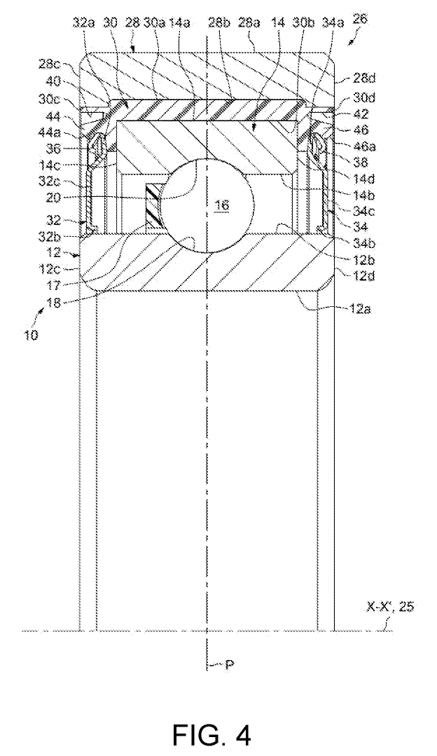

The bearing device illustrated in FIGS. 1 to 5 comprises a bearing 10 having a first ring 12 and a second ring 14 which can rotate in relation to one another around the axis X-X’ of the bearing. In the embodiment illustrated, the first ring 12 is the inner ring of the bearing, and the second ring 14 is the outer ring.

The bearing device includes electrical insulation so that it does not conduct currents.

The first ring 12 and second ring 14 of the bearing are concentric and extend axially along the axis X-X’ of the bearing. The first ring 12 and second ring 14 rings are made of steel. The rings are of the solid type.

In the embodiment illustrated, the bearing 10 also comprises a row of rolling elements 16, in this case balls, which are interposed radially between the first ring 12 and the second ring 14. The rolling elements 16 are made of steel. The bearing 10 also comprises a cage 17 for maintenance of the regular circumferential spacing of the rolling elements 16.

The first ring 12 comprises a cylindrical bore 12a, a cylindrical axially extending outer surface 12b radially opposite the bore 12a and first and second axially spaced radially extending front faces 12c, 12d delimiting the bore and the cylindrical outer surface 12b. The bore 12a and the outer surface 12b delimit the radial thickness of the first ring 12. The bore 12a forms the inner surface of the first ring. The first and second frontal surfaces 12c, 12d delimit the axial length of the first ring 12. The first ring 12 also has an inner race 18 for the rolling elements 16, which is formed on the outer surface 12b. The race inner 18 is directed radially outward.

The second ring 14 comprises a cylindrical axially extending outer surface 14a, a cylindrical inner surface 14b radially opposite the outer surface 14a, and first and second axially spaced radially extending frontal surfaces 14c, 14d delimiting the inner surface 14b and the outer surface 14a axially. The outer surface 14a and the inner surface 14b delimit the radial thickness of the second ring 14. The first and second faces 14c, 14d delimit the axial length of the second ring 14. The second ring 14 also comprises an outer race 20 for the rolling elements 16, which is formed on the inner surface 14b. The outer race 20 is directed radially inward.

The bearing device also comprises an electrical insulation sleeve 26 which is fitted on the second ring 14. The insulation sleeve 26 is fitted on the outer surface 14a of the second ring 14. The insulation sleeve 26 is integral with the second ring 14. The insulation sleeve 26 comprises a bushing 28 and an insulating insert 30 interposed radially between the second ring 14 and the bushing 28. The insulating insert 30 is in this case overmolded on the second ring 14 and on the bushing 28.

As will be described in greater detail hereinafter, the bearing device also comprises first and second sealing flanges 32, 34, which are secured on the insulating insert 30.

The bushing 28 has an annular form. The bushing 28 is produced in monobloc form. The bushing 28 is in this case produced in a single piece. Preferably, the bushing 28 is made of steel. The bushing 28 can advantageously be obtained from a tube or from forged and/or rolled blanks, or also by stamping.

The bushing 28 comprises a cylindrical axial outer surface 28a, and a cylindrical axial inner surface 28b radially opposite the outer surface 28a. The inner surface 28b forms the inner surface of the bushing 28. The inner surface 28b is oriented radially inward, i.e. facing the second ring 14 and the insulating insert 30. The axis 25 of the inner surface 28b is coaxial with the axis X-X’. The inner surface 28b is radially spaced from the outer surface 14a of the second ring.

The outer surface 28a and the inner surface 28b delimit the radial thickness of the bushing 28. The outer surface 28a of the bushing forms the outer surface of the bearing device 10. In other words, the outer surface 28a defines the outer diameter of the bearing device 10.

The bushing 28 also comprises first and second axially spaced radially extending front faces 28c, 28d delimiting axially the bore and the outer surface. The front faces 28c, 28d delimit the axial length of the bushing.

The front faces 14c, 28c of the second ring and of the bushing are situated axially on a first side in relation to a median radial plane P of the device, and the front faces 14d, 28d of the second ring and of the bushing are situated axially on a second side in relation to the median radial plane P, which is opposite the first side. In this case, the median radial plane P passes through the center of the rolling elements 16.

The front face 14c of the second ring is offset axially inward in relation to the front face 28c of the bushing. The front face 14d of the second ring is offset axially inward in relation to the front face 28d of the bushing. In other words, the front faces 14c, 14d of the second ring are axially recessed in relation to the front faces 28c, 28d of the bushing. The axial dimension of the second ring 14 is smaller than the axial dimension of the bushing 28.

The front face 14c of the second ring is offset axially inward in relation to the front face 12c of the first ring. The front face 14d of the second ring is offset axially inward in relation to the front face 12d of the first ring.

The insulating insert 30 is made of electrically insulating material. The insulating insert 30 can for example be made of synthetic material such as a PEEK or a PA46, or it can also be made of elastomer material, for example of rubber. Advantageously, the insulating insert 30 is made of flexible electrically insulating material.

The insulating insert 30 is interposed radially between the outer surface 14a of the second ring and the inner surface 28b of the bushing. The insulating insert 30 covers the outer surface 14a of the second ring. The insulating insert 30 in this case covers the outer surface 14a of the second ring entirely, taking into consideration the axial and circumferential directions. The insulating insert 30 also covers the front faces 14c, 14d of the second ring.

The insulating insert 30 also covers the inner surface 28b of the bushing. The insulating insert 30 in this case also covers the inner surface 28b entirely, taking into consideration the axial and circumferential directions.

The insulating insert 30 has an annular form. The insulating insert 30 extends axially. The insulating insert 30 comprises a cylindrical axial outer surface 30a, a cylindrical inner surface 30b radially opposite the outer surface 30a, and first and second axially opposite radially extending front faces 30c, 30d, delimiting axially the bore and the outer surface. The radial front faces 30c, 30d delimit the insulating insert 30 axially. The outer surface 30a and the inner surface 30b delimit the radial thickness of the insulating insert 30. The outer surface 30a is in radial contact with the inner surface 28b of the bushing. The inner surface 30b is in radial contact with the outer surface 14a and with the front faces 14c, 14d of the second ring. The inner surface 30b has a stepped form.

The front face 14c of the second ring is offset axially inward in relation to the front face 30c of the insulating insert. The front face 14d of the second ring is offset axially inward in relation to the front face 30d of the insulating insert.

In the embodiment illustrated, the faces 30c, 28c and 30d, 28d of the insulating insert and of the bushing are respectively substantially coplanar. Alternatively, it is possible to provide other arrangements. For example, the bushing 28 could extend axially projecting from the insulating insert 30 in relation to the faces 30c and 30d, or remain axially recessed from these faces.

In the embodiment illustrated, the faces 12c, 28c and 12d, 28d of the first ring and of the bushing are respectively coplanar. Alternatively, it is possible to provide other arrangements. For example, the bushing 28 could extend axially projecting in relation to the faces 12c and 12d of the first ring, or remain axially recessed from these faces.

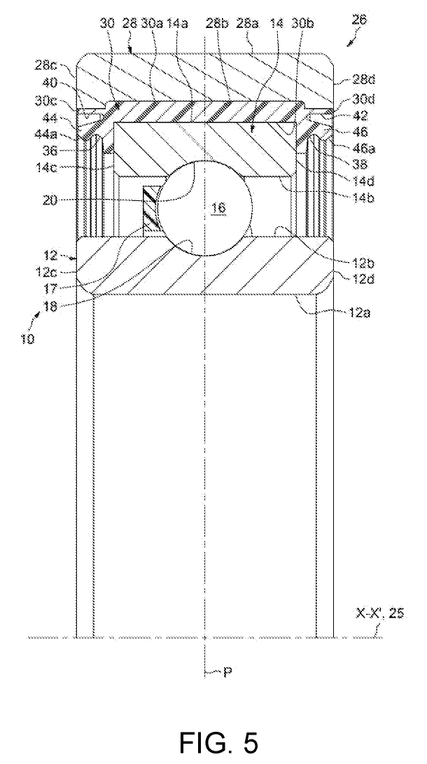

As shown more clearly in FIG. 5, the insulating insert 30 comprises first and second annular grooves 36, 38 formed on the inner surface 30b and open radially inward toward the first ring. Each groove 36, 38 extends around 360°. The base of each groove 36, 38 forms a continuous surface in the circumferential direction.

The sealing flanges 32, 34 are secured respectively in the grooves 36, 38 of the insulating insert. The grooves 36, 38 make it possible to fit sealing flanges 32, 34 on the insulating insert.

The groove 36 is formed on the inner surface 30b of the insulating insert, while being offset axially on the inner side of the device in relation to the front face 30c, and while being offset axially on the outer side of the device in relation to the front face 14c of the second ring. The groove 36 is offset axially on the inner side of the device in relation to the front face 12c of the first ring.

Similarly, the groove 38 is formed on the inner surface 30b of the insulating insert, while being offset axially on the inner side of the device in relation to the front face 30d, and while being offset axially on the outer side of the device in relation to the front face 14d of the second ring. The groove 38 is offset axially on the inner side of the device in relation to the front face 12d of the first ring.

The grooves 36, 38 are symmetrical with one another in relation to the median radial plane P of the device.

The insulating insert 30 comprises first and second annular release grooves 40, 42 which are provided respectively on the front faces 30c, 30d of the insulating insert. The groove 40 is offset radially on the side of the bushing 28, i.e. radially outward, in relation to the groove 36. The groove 40 surrounds the groove 36 radially. The groove 40 remains radially spaced from the outer surface 30a of the insulating insert. The groove 40 is oriented and open axially towards the outside of the insulating insert. The groove 40 is formed on the front face 30c of the insulating insert, and extends axially inward. The groove 40 remains axially spaced from the front face 14c of the second ring.

A first annular heel 44 remains radially between the grooves 36, 40. The bore of the heel 44 is delimited by the groove 36, and the outer surface of the heel is delimited by the groove 40. The free end of the heel 44 partly delimits the front face 30c of the insulating insert. The heel 44 of the insulating insert has a frustoconical surface 44a extending from the front face 30c, in the direction of the second ring, and being connected to the bore of the heel. The frustoconical surface 44a is situated radially on the side of the groove 36.

Similarly, the groove 42 is offset radially on the side of the bushing 28 in relation to the groove 38. The groove 42 surrounds the groove 38 radially. The groove 42 remains radially spaced from the outer surface 30a of the insulating insert. The groove 42 is oriented and open axially towards the outer of the insulating insert. The groove 42 is formed on the front face 30d of the insulating insert, and extends axially towards the inner. The groove 42 remains axially spaced from the front face 14d of the second ring. The grooves 40, 42 are symmetrical with one another in relation to the median radial plane P of the device.

A second annular heel 46 remains radially between the grooves 38, 42. The bore of the heel 46 is delimited by the groove 38, and the outer surface of the heel is delimited by the groove 42. The free end of the heel 46 delimits partly the front face 30d of the insulating insert. The heel 46 of the insulating insert has a frustoconical surface 46a extending from the front face 30d in the direction of the second ring, and being connected to the bore of the heel. The frustoconical surface 46a is situated radially on the side of the groove 38.

As previously indicated, the sealing flanges 32, 34 are secured in the grooves 36, 38 of the insulating insert. The sealing flanges 32, 34 are situated axially on each side of the insulating insert 30, in order to close the radial space which exists between the lining and the first ring 12, and in the inner of which there are accommodated the second ring 14, the rolling elements 16 and the cage 17. The sealing flanges 32, 34 are situated axially on both sides of the second ring 14. In this embodiment, the sealing flanges 32, 34 are identical to one another and symmetrical in relation to the median P of the device.

Each sealing flange 32, 34 is positioned radially between the insulating insert 30 and the first ring 12, and is secured on the insulating insert while being positioned laterally in relation to the second ring 14.

Each sealing flange 32, 34 is accommodated entirely in the interior of the radial space delimited by the insulating insert 30 and the first ring 12. The sealing flange 32, 34 is situated axially between the front face 14, 14d of the second ring, and the front face 28, 28d of the bushing. The sealing flange 32, 34 respectively, is offset axially on the inner side of the device in relation to the front faces 12c, 28c and 30c, and 12d, 28d and 30d respectively, of the first ring 12, the bushing 28 and the insulating insert 30. Each sealing flange 32, 34 is made of rigid material, for example metal material or thermoplastic material, in particular polyamide.

The sealing flange 32, 34 comprises a securing portion 32a, 34a which is secured in the groove 36, 38 of the insulating insert, a sealing portion 32b, 34b which cooperates with the first ring 12, and a connection portion 32c, 34c which connects the securing and sealing portions.

The securing portion 32a, 34a of the sealing flange is forced into the groove 36, 38, in order to secure the sealing flange 32, 34 on the insulating insert 30. In the embodiment illustrated, the securing portion 32a, 34a of the sealing flange 32, 34 is produced in the form of sectors which are folded back on themselves in order to match the form of the groove 36, 38. The sectors are spaced from one another in the circumferential direction. Alternatively, the securing portion 32a, 34a of the sealing flange 32, 34 could be annular (continuous).

The sealing portion 32b, 34b of each sealing flange is in the form of an annular axial portion which surrounds the outer surface 12b of the first ring radially, in order to form a narrow passage of the labyrinth type with the outer surface. The sealing portion 32b, 34b of each sealing flange forms a dynamic annular seal with the outer surface 12b of the first ring 12. Alternatively, the sealing portion 32b, 34b of each sealing flange, or of one of the two sealing flanges, could form a dynamic seal with another part of the first ring 12, for example the front face 12c, 12d.

In order to produce the bearing device, the procedure is as follows. In a first step, the bushing 28 and the second ring 14 of the bearing are fitted in the inner of a mold which is designed for over-molding of the insulating insert 30. Next, in a second step, the insulating insert 30 is over-molded both on the second ring 14 and on the bushing 28. Then, in a third successive step, the unitary whole formed by the second ring 14, the bushing 28 and the insulating insert 30, is extracted from the mold. Next, in a fourth step, the front faces 28c, 28d of the bushing are rectified. During this step, the outer surface 28a of the bushing and the race 20 of the second ring can also be rectified. Finally, in a fifth step, the unitary whole, formed by the second ring 14, the bushing 28 and the insulating insert 30, is assembled with the row of rolling elements 16, the cage 17, the first ring 12 and the sealing flanges 32, 34.

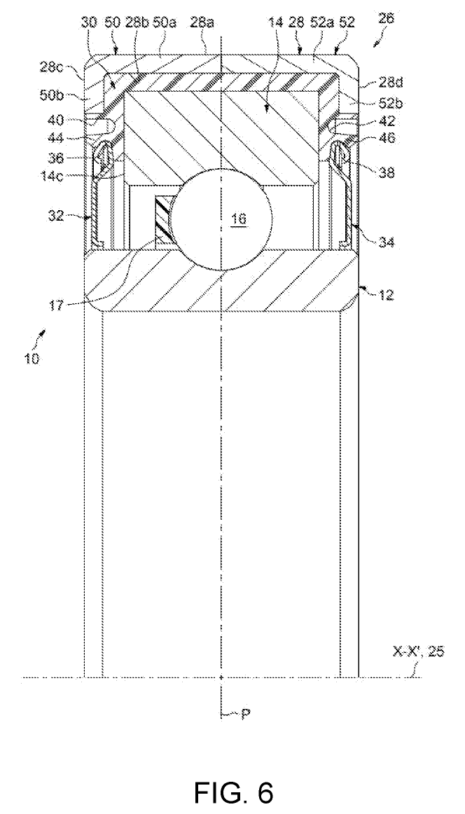

The embodiment illustrated in FIG. 6, in which identical elements bear the same references, differs from the first example in that the bushing 28 is constituted by two distinct parts 50, 52. These two separate parts 50, 52 form half-flanges, which in this case are axially supported against one another. In the embodiment illustrated, the parts 50, 52 of the bushing are identical, and symmetrical in relation to the median radial plane P of the device, in order to reduce the production costs. It will be appreciated that alternatively, it is possible to provide non-symmetrical parts 50, 52. In another variant, it could be possible for the bushing 28 to be constituted by more than two parts. In another variant, the bushing 28 could be produced in monobloc form. Preferably, the parts 50, 52 of the bushing 28 are made of steel. The parts 50, 52 can advantageously be obtained from a metal sheet, by cutting, stamping and rolling.

Each part 50, 52 of the bushing comprises an annular axial portion 50a, 52a, and an annular radial flange 50b, 52b, which extends the axial portion radially towards the inner. The axial portions 50a, 52a are axially supported against one another. The radial flange 50b, 52b extends the end of the axial portion 50a, 52a which is situated axially on the outer side of the device. In the embodiment illustrated, the radial flanges 50b, 52b are annular. Alternatively, at least one of the radial flanges 50b, 52b could be in the form of sectors which are spaced from one another in the circumferential direction. In the embodiment illustrated, the radial flanges 50b, 52b of the bushing extend radially beyond the outer surface 14a of the second ring, i.e. radially projecting towards the inner in relation to the outer surface 14a.

The axial portions 50a, 52a of the parts of the bushing delimit jointly the outer surface 28a of the bushing. Similarly, the axial portions 50a, 52a delimit jointly the inner surface 28b of the bushing. The front face 28c of the bushing is delimited by the radial flange 50b, and the front face 28d is delimited by the radial flange 52b. More specifically, the front face 28c is delimited by the outer face of the radial flange 50b, and the front face 28d is delimited by the outer face of the radial flange 52b.

The insulating insert 30 covers the inner face of each flange 50b, 52b of the bushing. The inner face, and the outer face axially opposite the inner face of each flange 50b, 52b delimit the axial thickness of the flange. For each flange 50b and 52b, the inner face is oriented axially towards the inner of the device, and the outer face is oriented axially towards the outer of the device. The insulating insert 30 also covers the free end of each flange 50b, 52b of the bushing.

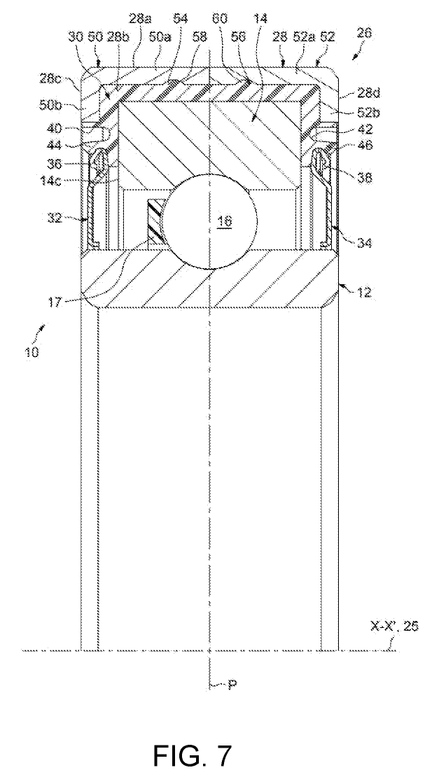

The embodiment illustrated in FIG. 7, in which elements that are identical bear the same references, differs from the second example and that the bore of the axial portion 50a, 52a of each part 50, 52 of the bushing is provided with a groove 54, 56 which extends circumferentially around the axis 25 of the bore of the bushing. Each groove 54, 56 is oriented radially on the side of the second ring 14, i.e. radially towards the interior.

In the embodiment illustrated, each groove 54, 56 is annular. Alternatively, at least one of the two grooves 54, 56 need not extend around 360°, or it could be formed by a succession of turns which extend circumferentially and are spaced from one another in the circumferential direction.

Each groove 54, 56 is delimited in the axial direction by two facing lateral flanks which have a straight profile in axial cross-section, and are connected to one another by an axial base. Alternatively, other forms can be provided, for example grooves which in this case in straight cross-section have the form of an arc of a circle oriented towards the interior.

The insulating insert 30 also comprises two ribs 58, 60 extending radially towards the outside from the outer surface 30a, and each accommodated in the inner of one of the grooves 54, 56 of the bushing. The rib 58, 60 has a form complementary to the associated groove 54, 56. Each rib 58, 60 extends projecting from the outer surface 30a of the insulating insert. Each rib 58, 60 is formed on the outer surface 30a during the over-molding of the insulating insert 30.

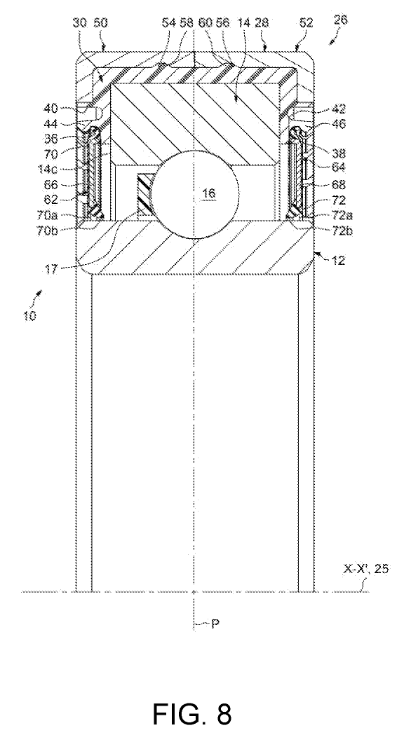

The embodiment illustrated in FIGS. 8 and 9, wherein elements which are identical bear the same references, differs mainly from the third example in that the bearing device comprises other sealing devices, as a replacement for the sealing flanges, in this case seals 62, 64 which are secured on the insulating insert 30.

Since the arrangement of the seals 62, 64 in relation to the insulating insert 30, and to the inner 12 and outer 14 rings, is identical to that of the sealing flanges of the preceding examples, it will not be described again.

The seal 62, 64 comprises a rigid annular insert 66, 68, and a flexible annular sealing lining 70, 72 secured on the insert. The insert 66, 68 is made of a rigid material, for example metal material, or thermoplastic material, in particular polyamide. The lining 70, 72 is over-molded or vulcanized on the insert 66, 68. The lining 70, 72 is made of a flexible material, for example of an elastomer such as a nitrile rubber or thermoplastic elastomer.

The lining 70, 72 of each seal forms two opposite radially outer and inner sealing portions, which form respectively a static seal with the insulating insert 30, and a dynamic annular seal with the first ring 12.

The outer sealing portion of the lining 70, 72 of the seal is forced into the groove 36, 38 of the insulating insert. In the area of the groove 36, 38, the outer sealing portion is in complementarity of form with the groove, in order to form a part for securing of the seal 62, 64 on the second ring 14. The outer sealing portion of the lining 70, 72 of the seal surrounds radially and axially the free edge with a large diameter of the insert 66, 68, such that only the lining is in contact with the second ring 14. This therefore assists good retention in position of the seal 62, 64 in the inner of the groove 36, 38 by forcing in and by friction.

The inner sealing portion of the lining 70, 72 of the seal comprises first and second concentric annular inner lips 70a and 70b, 72a and 72b extending axially towards the inner of the bearing. Each lip 70a, 70b and 72a, 72b surrounds radially the outer surface 12b of the first ring, in order to form a narrow passage of the labyrinth type with the outer surface. Each lip 70a, 70b and 72a, 72b forms a dynamic seal with the outer surface 12b of the first ring 12. Alternatively, each lip 70a, 70b and 72a, 72b could form a dynamic seal with another part of the first ring 12, for example the front face 12c, 12d. In another variant, at least one of the two lips 70a and 70b, 72a and 72b of each inner sealing portion of the seal 70, 72, or one of the two sealing portions, could come into friction contact with the first ring 12.

In this embodiment, each heel 44, 46 of the insulating insert is slit, and is constituted by a plurality of sectors which are spaced from one another in the circumferential direction. The base of each groove 36, 38 forms a discontinuous surface in the circumferential direction, but the groove remains annular, i.e. it extends around 360°. The different sectors of the heel 44, 46 are brought towards one another, such that the groove 36, 38 of the insulating insert always has a form which extends around 360°. The circumferential space between two successive sectors of the heel 44, 46 is for example smaller than 1.2 mm.

In the embodiments illustrated, the first ring 12 of the bearing is the inner ring, and the second ring 14 on which the insulating insert 30 is over-molded is the outer ring.

Alternatively, it is possible to provide an inverted arrangement in which the second ring 14 on which the insulating insert 30 is secured is the inner ring. In this case, the insulation sleeve is situated in the bore 12a of the inner ring. The insulating insert is then interposed radially between the bore 12a of the inner ring and the outer surface of the bushing. The insulating insert is secured at least on the inner surface of the first ring, and at least on the outer surface of the bushing. The bore of the bushing delimits the bore of the bearing device. The sealing device is/are secured in annular fitting grooves formed on the outer surface of the insulating insert.

In the embodiments described, the bearing of the device is provided with a single row of rolling elements. As a variant, the bearing can be provided with a plurality of rows of rolling elements. In addition, the roller bearing can comprise types of rolling elements other than balls, for example rollers. In another variant, the bearing can be a slide bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electrically insulated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the second ring having a first axial end and a second axial end axially spaced from the first axial end and a first radial side extending from the first axial end to the second axial end and a second radial side extending from the first axial end to the second axial end, the second radial side being radially spaced from the first radial side,
a bushing,
an electrically insulating insert overmolded between and connecting the bushing and the second radial side of the second ring, the electrically insulating insert having a first axial end and a second axial end axially spaced from the first axial end of the electrically insulating insert and a first radial side extending from the first axial end of the electrically insulating insert to the second axial end of the electrically insulating insert and a second radial side extending from the first axial end of the electrically insulating insert to the second axial end of the electrically insulating insert, and
a first sealing device secured in a first annular fitting groove of the electrically insulating insert, the first sealing device forming a first dynamic annular seal with the first ring.

2. The bearing device according to claim 1,
wherein the first annular groove of the electrically insulating insert is open toward the first ring.

3. The bearing device according to claim 1,
including a first release groove radially offset from the first fitting groove, the first release groove being formed in the first axial end of the electrically insulating insert, and
a first heel radially between the first fitting groove and the first release groove.

4. The bearing device according to claim 3,
wherein the first heel has a frustoconical surface extending from the first axial end of the electrically insulating insert,
wherein the first heel is located radially between the first fitting groove and the first release groove.

5. The bearing device according to claim 4,
wherein the first sealing device comprises a securing part which is secured in the first annular fitting groove, and
wherein the first sealing device is formed from a material having a rigidity greater than a rigidity of a material of the electrically insulating insert.

6. The bearing device according to claim 5,
wherein the first sealing device comprises a sealing flange or a sealing gasket.

7. The bearing device according to claim 6,
including a second sealing device secured in a second annular fitting groove of the insulating insert, the second sealing device forming a second dynamic annular seal with the first ring,
wherein the second sealing device is located on an axially opposite side of the second ring from the first dynamic annular sealing device.

8. The bearing device according to claim 7,
wherein the first ring includes a first axial end axially spaced from a second axial end,
wherein an axial width of the second ring is less than an axial width of the first ring, and
wherein the first sealing device is located axially between the first axial end of the first ring and the first axial end of the second ring.

9. An electric motor comprising:
a housing,
a shaft, and
a bearing device according to claim 1 fitted radially between the housing and the shaft.
